(19) United States
(12) Patent Application Publication
(10) Pub. No.: US 2009/0154505 A1
(43) Pub. Date: Jun. 18, 2009

(54) WAVELENGTH TUNABLE LASER DIODE USING DOUBLE COUPLED RING RESONATOR

(75) Inventors: Kwang Ryong OH, Daejeon (KR); Jong Hoi Kim, Daejeon (KR); Dong Churl Kim, Daejeon (KR); Oh Kee Kwon, Daejeon (KR); Ki Soo Kim, Daejeon (KR); Ki Hong Yoon, Daegu (KR)

Correspondence Address: RABIN & Berdo, PC, 1101 14TH STREET, NW, SUITE 500, WASHINGTON, DC, 20005, US

(73) Assignee: Electronics and Telecommunications Research Institute, Daejeon (KR)

(21) Appl. No.: 12/181,734

(22) Filed: Jul. 29, 2008

(30) Foreign Application Priority Data
Dec. 17, 2007 (KR) 10-2007-0132764

(51) Int. Cl. H01S 3/10

(52) U.S. Cl. 372/20

(57) ABSTRACT

A wavelength tunable laser diode using a double coupled ring resonator is provided. A new double coupled ring resonator structure is formed by a connection of two ring resonators having different radii so that stable laser oscillation occurs only in a resonant wavelength at which the two ring resonators are simultaneously resonated, and the effective refractive index of the two ring resonators is properly controlled differently for tunable laser oscillation wavelengths. The reproducibility of the optical coupling characteristics of the passive waveguides and the ring resonator can be assured by multi-mode couplers. This results in improved manufacturing productivity of the wavelength tunable laser diode. It is possible to amplify and output an output light without having an effect on oscillation wavelength characteristic by means of an optical amplifier integrated in an output end.

### CROSS-REFERENCE TO RELATED APPLICATION

This application claims priority to and the benefit of Korean Patent Application No. 2007-132764, filed Dec. 17, 2007, the disclosure of which is incorporated herein by reference in its entirety.

### BACKGROUND

1. Field of the Invention The present invention relates to a wavelength tunable laser diode using a double coupled ring resonator, and more particularly, to a wavelength tunable laser diode using a double coupled ring resonator including two coupled ring resonators connected to each other to have a high output characteristic, a wide-band wavelength tunability, a rapid wavelength tunability, a high-speed direct modulation characteristic, and ease of manufacture.

This work was supported by the IT R&D program of MIC/IITA[2006-S-059-02, ASON based Metro Photonic Cross-Connect Technology].

2. Discussion of Related Art

A wavelength tunable laser diode is an optical part that is essential to wavelength division multiplexing optical communication.

Such a wavelength tunable laser diode should have a high output characteristic (>10 mW), a wide-band wavelength tunability (>32 nm), a rapid wavelength tunability (>10 ns), and a high-speed direct modulation characteristic (>2.5 Gbps) in order to meet specifications required in various applications. Productivity is of most importance. Complexity, reproducibility, reliability, and mass productivity must be considered.

Representative wavelength tunable laser diodes currently developed or proposed include a Sampled Grating Distributed Bragg Reflector (SG-DBR) laser diode using dispersive and regressive reflection characteristics of diffraction gratings formed in a passive waveguide region or a gain waveguide region, a Super-Structure Grating Distributed Bragg Reflector (SSG-DBR) laser diode with a periodically modulated grating period, and a Grating-Assisted Codirectional-coupler with Sampled grating Reflector (GCSR) laser diode coupled with a sampled grating reflector, or the like.

However, although these laser diode devices are excellent in performance, they do not completely solve problems in the manufacturing complexity and continuity of wavelength tunability.

To solve these problems, various structures have been proposed that use a ring resonator having a relatively large quality factor (Q factor), as will be described below.

FIGS. 1a to 1d illustrate a wavelength tunable laser diode using the conventional ring resonator.

The wavelength tunable laser diode shown in FIG. 1a has a structure in which a MACH-ZEHNDER filter 9 having a wide bandwidth is coupled with a ring resonator 10 having a narrow bandwidth. Among beams branched by a Y-branching device 7, only beams matching a resonant wavelength of the ring resonator 10 are coupled and returned to the MACH-ZEHNDER filter 9 and beams not matching the resonant wavelength of the ring resonator 10 are output through output waveguides 2 and 3.

However, a change in a refractive index with voltage or current is considerably limited due to limited III-V compound semiconductor material characteristics based on InP, GaAs, or the like constituting the waveguide. Accordingly, with the wavelength tunable laser diode structure as shown in FIG. 1a, it is difficult to obtain wide-band wavelength tunability.

The wavelength tunable laser diode shown in FIG. 1b has a structure in which two waveguides 21 and 25 intersect with each other and are simultaneously coupled with one ring resonator 23 and two waveguides 22 and 26 intersect with each other and are coupled with the other ring resonator 24. A beam at a resonant frequency regresses to an optical amplifier 27, causing laser oscillation, and an optical signal with a wavelength not coupled between the waveguide and the ring resonator is absorbed and removed by an optical absorber 28

The wavelength tunable laser diode structure as shown in FIG. 1b may have the wide-band wavelength tunability. However, the wavelength tunable laser diode structure is difficult to actually implement, for example, due to poor reproducibility of optical coupling characteristics of the ring resonator and the waveguides and a complex structure including the optical absorber.

The wavelength laser diode shown in FIG. 1c has a structure in which an optical phase shifter 30 is coupled with an optical amplifier 27, and two ring resonators 23 and 24 are commonly coupled with one waveguide 29, and simultaneously the coupling occurs even between the two ring resonators 23 and 24, thus a filtered wavelength beam regresses back. A basic wavelength tuning scheme is similar to that in FIG. 1b. That is, a wavelength is selected by finely controlling a refractive index with the two ring resonators 23 and 24 having different free spectral ranges.

The wavelength tunable laser diode structure as shown in FIG. 1c has an advantage of allowing integration of the optical phase shifter 30 and the optical amplifier 27 in a hybrid manner. However, the wavelength tunable laser diode has a problem of low productivity due to poor reproducibility of optical coupling characteristics of the ring resonators 23 and 24 and the waveguide 29.

The wavelength tunable laser diode as shown in FIG. 1d has a structure in which an optical signal is coupled from an optical amplifier 27 to a ring resonator 23 through a waveguide 29, and then, sequentially coupled to a waveguide 33, a ring resonator 24, and a waveguide 34, causing the optical signal is reflected by the waveguide 34 on an upper side and regresses to an input side.

However, the wavelength tunable laser diode as shown in FIG. 1d is difficult to implement in reality due to poor reproducibility of optical coupling characteristics of the waveguide and the ring resonator.

### SUMMARY OF THE INVENTION

Therefore, the present invention has been proposed to solve the above problems. The present invention is directed to a wavelength tunable laser diode using a double coupled ring resonator including two connected ring resonators to have a high output characteristic, a wide-band wavelength tenability, a rapid wavelength tunability, a high-speed direct modulation characteristic, and ease of manufacture.

In order to accomplish the above object, one aspect of the present invention provides a wavelength tunable laser diode using a double coupled ring resonator comprising: first and second passive waveguides connected to both terminals of a first optical amplifier; a third passive waveguide arranged in parallel with the first and second passive waveguides; a double coupled ring resonator including first and second ring resonators connected to each other and having different radii, the double coupled ring resonator being coupled between the first and second passive waveguides and the third passive waveguide; and first and second electrodes for applying current or voltage to the first and second ring resonators, respectively.

Effective refractive indexes of the first and second ring resonators are changed according to the voltage or the current applied to the first and second electrodes so that laser oscillation occurs in a resonant wavelength at which the first and second ring resonators are simultaneously resonated.

First and second multi-mode couplers may be coupled between the first passive waveguide and the first ring resonator and between the second passive waveguide and the second ring resonator, respectively, and third and fourth multi-mode couplers may be coupled between the first ring resonator and the third passive waveguide and between the second ring resonator and the third passive waveguide.

A second optical amplifier may be integrated on any one of the first and second passive waveguides.

### BRIEF DESCRIPTION OF THE DRAWINGS

The above and other features and advantages of the present invention will become more apparent to those of ordinary skill in the art by describing in detail preferred embodiments thereof with reference to the attached drawings in which:

FIGS. 1a to 1d illustrate a wavelength tunable laser diode using the conventional ring resonator;

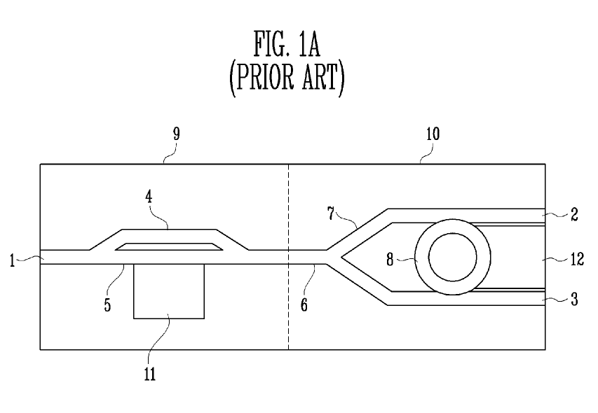

FIG. 2 illustrates a wavelength tunable laser diode according to a first embodiment of the present invention;

FIG. 3 illustrates a wavelength tunable laser oscillation structure of the present invention;

FIG. 4 illustrates a wavelength tunable laser diode according to a second exemplary embodiment of the present invention; and

FIG. 5 illustrates a wavelength tunable laser diode according to a third exemplary embodiment of the present invention;

### DETAILED DESCRIPTION OF PREFERRED EMBODIMENTS

Hereinafter, a wavelength tunable laser diode using a double coupled ring resonator according to the present invention will be described with reference to the accompanying drawings.

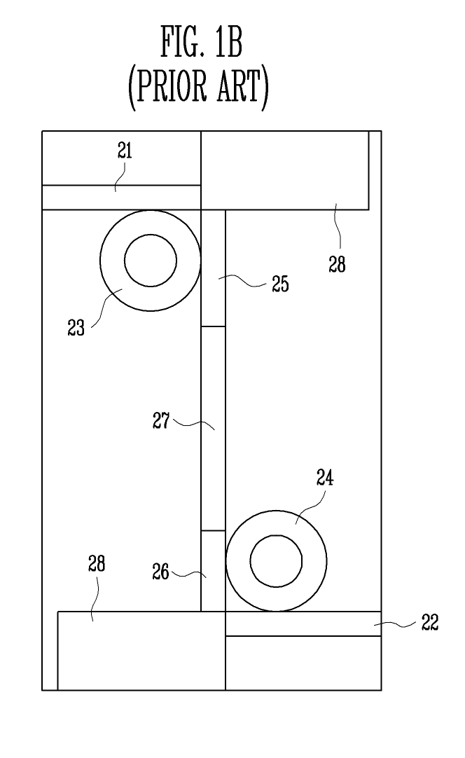

FIG. 2 illustrates a wavelength tunable laser diode according to a first embodiment of the present invention.

Referring to FIG. 2, the wavelength tunable laser diode according to the first embodiment of the present invention includes first and second passive waveguides 25 and 26, a first optical amplifier 27, a third passive waveguide 33, first and second ring resonators 23 and 24, and first and second electrodes 35 and 36.

The first and second passive waveguides 25 and 26 are connected to both terminals of the first optical amplifier 27, respectively, and the third passive waveguide 33 is arranged in parallel with the first and second passive waveguides 25 and 26.

Between the first passive waveguide 25 and the third passive waveguide 33 and between the second passive waveguide 26 and the third passive waveguide 33 are coupled the first and second ring resonators 23 and 24 having different radii, respectively. In other words, one terminal of the first ring resonator 23 and one terminal of the second ring resonator 24 are respectively connected to the first and second passive waveguides 25 and 26 and the other terminal thereof is connected to the third passive waveguide 33.

When external voltage or current is applied to the first and second electrodes 35 and 36, a change in an effective refractive index is generated in a whole or a part of the first and second ring resonators 23 and 24. To change the effective refractive index of the first and second ring resonators 23 and 24, an amount of current flowing through the first and second ring resonators 23 and 24 may be changed by controlling the voltage or current applied to the first and second electrodes 35 and 36 or a reverse bias voltage may be applied to the first and second electrodes 35 and 36.

Antireflection coatings (not shown) may be formed on cross sections of first and second output ends 32a and 32b formed by cutting the first and second passive waveguides 25 and 26, in order to prevent oscillation caused by reflection-induced Fabry-Perot resonance.

The waveguide structures of the first to third passive waveguides 25, 26, and 33 and the first and second ring resonators 23 and 24 may be deep ridge waveguide structures, because the deep ridge waveguide shows a relatively smaller loss characteristic at its small radius than any other structures. Also, the waveguide structure for the first optical amplifier 27 may be a buried structure, a shallow ridge structure, or any other structure for efficient current restriction.

The present invention is characterized in that the connection of the first and second ring resonators 23 and 24 forms a new double coupled ring resonator structure in which stable laser oscillation occurs only in a resonant wavelength at which the two ring resonators are simultaneously resonated, and the effective refractive index of the two ring resonators is properly controlled differently for tunable laser oscillation wavelengths. The contents thereof will be described below in greater detail.

First, the structure of the double coupled ring resonator of the present invention will be described.

First, a first optical signal (indicated by a solid line) incident to the first passive waveguide 25 is coupled with the first ring resonator 23 to propagate in a counter-clockwise direction and is then coupled with the third passive waveguide 33 to propagate to the right side. Thereafter, the first optical signal is coupled with the second ring resonator 24 to propagate in a counter-clockwise direction and is then coupled with the second passive waveguide 26 to propagate to the first optical amplifier 27. The first optical signal is amplified by the first optical amplifier 27 and then input again to the first passive waveguide 25, thus forming the laser resonator.

Meanwhile, a second optical signal (indicated by a dotted line) incident to the second passive waveguide 26 is coupled with the second ring resonator 24 to propagate in a clockwise direction and is then coupled with the third passive waveguide 33 to propagate to the left side. Thereafter, the second optical signal is coupled with the first ring resonator 24 to propagate in a clockwise direction and is then coupled with the first passive waveguide 25 to propagate to the first optical amplifier 27. Thus, the second optical signal is amplified via the first optical amplifier 27 and again input to the second passive waveguide 26, thus forming the laser resonator.

In other words, the connection of the first and second ring resonators 23 and 24 forms a new double coupled ring resonator structure through which laser oscillation occurs.

Second, the wavelength tunable laser oscillation structure of the present invention will be described.

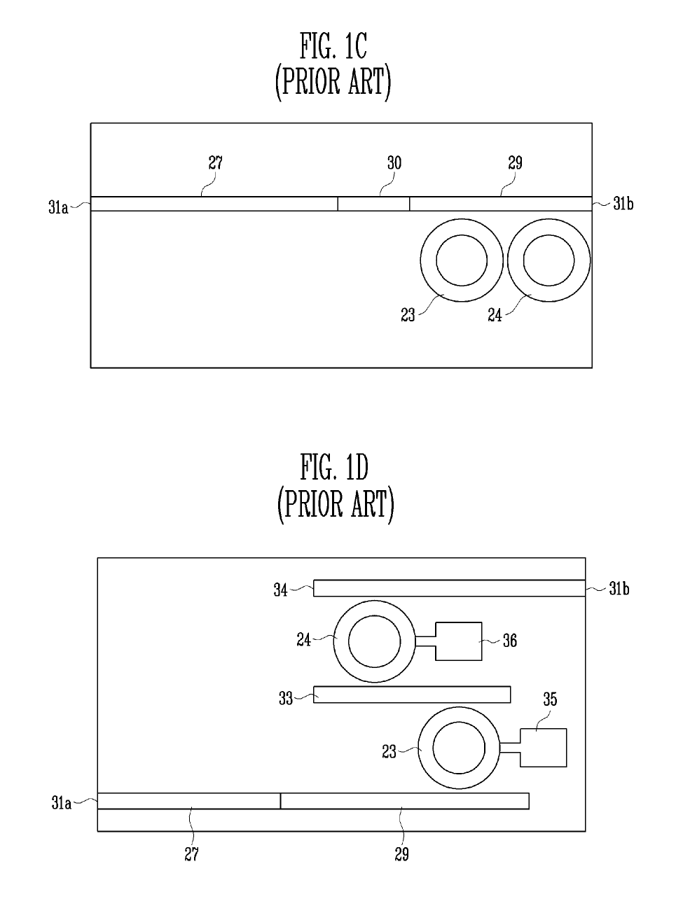

FIG. 3 illustrates a wavelength tunable laser oscillation structure of the present invention.

Referring to FIG. 3, when the effective refractive index of one of the first and second ring resonators 23 and 24 is fixed and the effective refractive index of the other is gradually increased or decreased, resonant peaks sequentially appear only in the wavelength at which the two resonators are simultaneously resonated, that is, the wavelength increased or decreased by one FSR, leading to laser oscillation.

In other words, when the refractive index of the first and second ring resonators 23 and 24 is properly controlled, the size of reflectivity in an FSR period is maximal in a particular wavelength and a maximum value of reflectivity in a wavelength spaced by an integer multiple of the FSR period from the wavelength showing the maximum reflectivity is gradually reduced.

Therefore, when the refractive index of the first and second ring resonators 23 and 24 is properly controlled, the maximum reflectivity wavelength can be changed over several tens of nm even in a small change in the refractive index. Such a reflection characteristic of the ring resonator may be used to implement the wide-band wavelength tunable laser diode. Also, since the laser resonant wavelength is determined by the length of an internal circulation optical path, it results in a stable oscillation characteristic.

Meanwhile, it is important to assure the reproducibility of the optical coupling characteristic of the optical waveguide and the ring resonator in the wavelength tunable laser diode. As in the case of FIG. 2, when the ring resonators 23 and 24 are directly coupled with the first to third passive waveguides 25, 26, and 33, an error in lithography and etching processes may lead to a change in a coupling rate and, in turn, a change in laser characteristic.

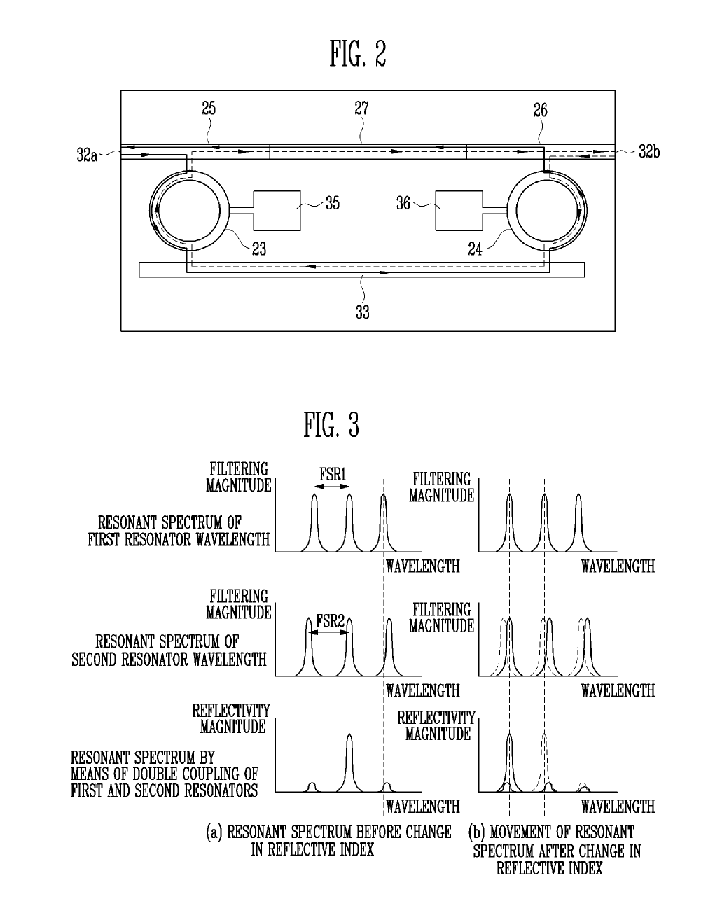

To assure the reproducibility of the optical coupling characteristic, the first and second ring resonators 23 and 24 are coupled with the first to third passive waveguides 25, 26, and 33 by using a multi-mode interferometry according to the present invention. This will be described below in greater detail with reference to FIG. 4.

FIG. 4 illustrates a wavelength tunable laser diode according to a second exemplary embodiment of the present invention.

Referring to FIG. 4, the wavelength tunable laser diode according to the second exemplary embodiment of the present invention is the same as that of FIG. 2, except that first and second multi-mode couplers 37a and 37b are coupled between a first passive waveguide 25 and a first ring resonator 23 and between a second passive waveguide 26 and a second ring resonator 24, respectively, and third and fourth multi-mode couplers 38a and 38b are coupled between the first ring resonator 23 and a third passive waveguide 33 and between the second ring resonator 24 and the third passive waveguide 33, respectively.

Here, the first and second multi-mode couplers 37a and 37b are 2×2 multi-mode couplers and the third and fourth multi-mode couplers 38a and 38b are 1×2 multi-mode couplers.

In other words, in the wavelength tunable laser diode configured as in FIG. 4, optical coupling rates of the first and second ring resonators 23 and 24 and the first to third passive waveguides 25, 26, and 33 are kept unchanged by the first and second multi-mode couplers 37a and 37b and the third and fourth multi-mode couplers 38a and 38b, thus assuring the reproducibility.

Meanwhile, the intensity of optical power output from the wavelength tunable laser diode has a very critical effect on improvement of communication performance. Where the output light is amplified by an optical amplifier connected to an output end, there is a risk of a change in oscillation wavelength characteristics according to connections of the optical amplifier.

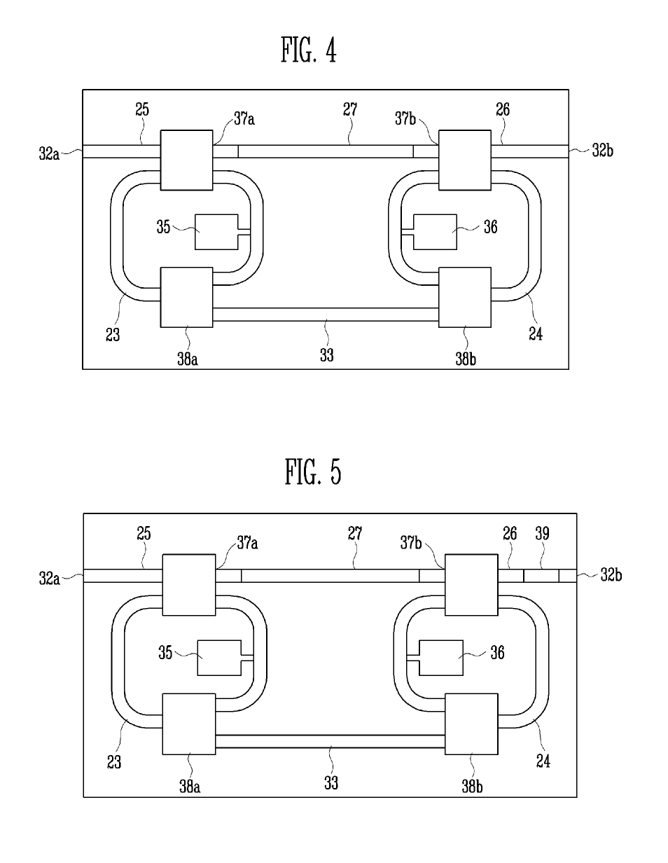

To this end, in the present invention the optical amplifier is integrated into the output end to amplify and output an output light without having an effect on the oscillation wavelength characteristic. This will be described in greater detail with reference to FIG. 5.

FIG. 5 illustrates a wavelength tunable laser diode according a third exemplary embodiment of the present invention.

Referring to FIG. 5, the wavelength tunable laser diode according to a third exemplary embodiment of the present invention is the same as that shown in FIG. 4, except that a second optical amplifier 39 for amplifying output light is integrated on a second passive waveguide 26.

The second optical amplifier 39 may be integrated on the second passive waveguide 26 at the same time when an antireflection coating (not shown) is formed on a cross section of a second output end 32b. Although the second optical amplifier 39 is integrated on the second passive waveguide 26 in the present embodiment, the optical amplifier may of course be integrated on a first passive waveguide 25.

In other words, optical signals whose wavelengths are tuned through first and second ring resonators 23 and 24 are amplified and output through the second optical amplifier 39, thus obtaining output light having high intensity without having an effect on the oscillation wavelength characteristic.

As described above, in the wavelength tunable laser diode of the present invention, the connection of the two ring resonators 23 and 24 having different radii forms a new double coupled ring resonator structure in which stable laser oscillation occurs only in a resonant wavelength at which the two ring resonators are simultaneously resonated, and the effective refractive index of the two ring resonators is properly controlled differently to tune the oscillation wavelengths of the laser for stable laser oscillation.

Also, the wavelength tunable laser diode of the present invention has an advantage of assuring the reproducibility of the optical coupling characteristics of the first to third passive waveguides 25, 26, and 33 and the first and second ring resonators 23 and 24 using the multi-mode couplers 37a, 37b, 38a and 38b.

Furthermore, the wavelength tunable laser diode of the present invention has an advantage of amplifying and outputting the output light without having an effect on the oscillation wavelength characteristic using the second optical amplifier 39 integrated in the output end.

While the invention has been shown and described with reference to exemplary embodiments thereof, it will be understood by those skilled in the art that various changes may be made therein without departing from the spirit and scope of the invention. Therefore, the disclosed embodiments should be considered in light of illustration, rather than limitation. The scope of the present invention is defined by the appended claims, rather than the above-mentioned description. It should be interpreted that equivalents of the appended claims are included in the present invention.

What is claimed is:

1. A wavelength tunable laser diode using a double coupled ring resonator comprising:
first and second passive waveguides connected to both terminals of a first optical amplifier;
a third passive waveguide arranged in parallel with the first and second passive waveguides;
a double coupled ring resonator including first and second ring resonators connected to each other and having different radii, the double coupled ring resonator being coupled between the first and second passive waveguides and the third passive waveguide; and
first and second electrodes for applying current or voltage to the first and second ring resonators, respectively.

2. The wavelength tunable laser diode according to claim 1, wherein the first ring resonator is coupled between the first passive waveguide and the third passive waveguide, and the second ring resonator is coupled between the second passive waveguide and the third passive waveguide.

3. The wavelength tunable laser diode according to claim 1, wherein effective refractive indexes of the first and second ring resonators are changed according to the current or voltage applied to the first and second electrodes so that laser oscillation occurs in a resonant wavelength at which the first and second ring resonators are simultaneously resonated.

4. The wavelength tunable laser diode according to claim 3, wherein when the effective refractive index of the first ring resonator is fixed and the effective refractive index of the second ring resonator is gradually increased or decreased, resonant peaks sequentially appear in a wavelength increased or decreased by a Free Spectral Range (FSR) of the second ring resonator.

5. The wavelength tunable laser diode according to claim 1, wherein first and second multi-mode couplers are coupled between the first passive waveguide and the first ring resonator and between the second passive waveguide and the second ring resonator, respectively, and
third and fourth multi-mode couplers are coupled between the first ring resonator and the third passive waveguide and between the second ring resonator and the third passive waveguide, respectively.

6. The wavelength tunable laser diode according to claim 5, wherein the first and second multi-mode couplers are 2×2 multi-mode couplers and the third and fourth multi-mode couplers are 1×2 multi-mode couplers.

7. The wavelength tunable laser diode according to claim 1, wherein a second optical amplifier is integrated on at least one of the first and second passive waveguides.

8. The wavelength tunable laser diode according to claim 1, wherein antireflection coatings are formed on cross sections of first and second output ends formed by cutting the first and second passive waveguides.
